(19) United States
(12) Patent Application Publication
(10) Pub. No.: US 2008/0247780 A1
(43) Pub. Date: Oct. 9, 2008

(54) ENDLESS BELT, ENDLESS BELT SUSPENDING APPARATUS, AND IMAGE FORMING APPARATUS USING THE SAME

(75) Inventor: Yukio HARA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/952,579

(22) Filed: Dec. 7, 2007

(30) Foreign Application Priority Data
Apr. 9, 2007 (JP) 2007-101685

(51) Int. Cl. G03G 15/01; G03G 15/00

(52) U.S. Cl. 399/162; 399/302

(57) ABSTRACT

The invention provides an endless belt for an image forming apparatus, the endless belt having at least: a belt body; a convex member; and a bonding portion for bonding the belt body and the convex member, the bonding portion having a glass transition temperature (Tg) of about −10° C. or less. The glass transition temperature (Tg) is preferably about −60° C. or less. The invention further provides a belt suspending apparatus for an image forming apparatus, the belt suspending apparatus having at least: the endless belt; and a plurality of suspending members for suspending the endless belt rotatably in a tensioned state from the inner surface side of the endless belt. The invention further provides an image forming apparatus having at least the endless belt.

This application is based on and claims priority under 35 USC 119 from Japanese Patent Application No. 2007-101685 filed Apr. 9, 2007.

### BACKGROUND

1. Technical Field

The present invention relates to an endless belt for an image forming apparatus, a belt suspending apparatus for the endless belt for an image forming apparatus, and an image forming apparatus using the endless belt.

2. Related Art

An example of an image forming apparatus using an electrophotographic method is a multicolor image forming apparatus utilizing an intermediate transcription method using an intermediate transfer belt. In this image forming apparatus, the intermediate transfer belt, which rotates while being brought in contact with a transfer portion of an image holding unit (for example a photosensitive drum) on which a toner image is formed by the electrophotographic method, is disposed by being suspended from a plurality of belt supporting rolls. Plural toner images as primary images formed on the image holding unit are transferred onto the intermediate transfer belt, and the toner images transferred onto the intermediate transfer belt are collectively transferred as a secondary image onto a recording medium. The secondary image that is a multicolor toner image transferred onto the recording medium is fixed with a fixing device to form a multicolor image.

An example of an image forming apparatus equipped with an endless belt for an image forming apparatus is a multicolor image forming apparatus utilizing a tandem method using a recording medium delivery belt for holding the recording medium and for delivering it through transfer portions of plural image forming units. In this image forming apparatus, a plurality of image forming units are aligned for independently forming toner images of respective color components, and the recording medium delivery belt is suspended between each pair of plural belt supporting rolls so that the belt is rotated in contact with the transfer part of each image forming unit. A recording medium, which is retained by being adhered to the recording medium delivery belt, is delivered through the transfer portion of each image forming unit. The toner images formed on respective image forming units are thus sequentially transferred onto the recording medium by being superimposed on one another, and finally a multicolor image is formed by fixing the toner images.

Since the endless belt for the image forming apparatus is sometimes stored at low temperatures below freezing when, for example, transported by air, the bonding portion is required to show good adhesiveness even after storage at low temperatures.

### SUMMARY

In view of the above circumstances, the present invention provides an endless belt for an image forming apparatus, in which a belt body and a convex member excellently adhere to each other even under changes in environmental conditions, a belt suspending apparatus for an image forming apparatus having the endless belt, and an image forming apparatus with which image defects are favorably suppressed.

According to a first embodiment of a first aspect of the invention, there is provided an endless belt for an image forming apparatus, including:

a belt body;

a convex member; and

a bonding portion for bonding the belt body and the convex member, the bonding portion having a glass transition temperature (Tg) of equal to or about −10° C. or less.

### BRIEF DESCRIPTION OF THE DRAWINGS

FIG. 1 is a perspective view of schematic configuration of an endless belt of an image forming apparatus according to a first exemplary embodiment of the invention;

FIG. 2 is a cross-sectional view showing a bonding portion between a belt body and a convex member in the endless belt of an image forming apparatus according to the first exemplary embodiment of the invention;

FIGS. 3A to 3D are explanatory diagrams illustrating a T-type peeling test;

FIGS. 4A to 4E are explanatory diagrams illustrating a thrust peeling test;

FIG. 5 is a schematic configurational view of the image forming apparatus according to a second exemplary embodiment of the invention, having the endless belt for an image forming apparatus as an intermediate transfer belt;

FIG. 6 is a schematic configurational view of the image forming apparatus according to a third exemplary embodiment of the invention, having the endless belt for an image forming apparatus as a paper delivery belt; and

FIG. 7 is a schematic configurational view of the image forming apparatus according to a fourth exemplary embodiment of the invention, having the endless belt for an image forming apparatus as an intermediate transfer belt.

### DETAILED DESCRIPTION

### Endless Belt for Image Forming Apparatus

Hereinafter, an endless belt for an image forming apparatus according to a first exemplary embodiment of the invention will be described with reference to the drawings.

The endless belt for an image forming apparatus according to the first exemplary embodiment of the invention includes: a belt body; a convex member; and a bonding portion for bonding the belt body and the convex member, the bonding portion having a glass transition temperature (Tg) of equal to or about −10° C. or less.

The endless belt for an image forming apparatus according to the first exemplary embodiment of the invention is favorably used for a photosensitive unit, an intermediate transfer unit, a transferred image separation unit, a delivery unit, a charging unit, a development unit, a fixing unit in an electrophotographic copy machine and a laser printer. The material, shape and size of the belt body configuring the endless belt for an image forming apparatus according to the first exemplary embodiment of the invention are determined depending on the use, function, or the like of the endless belt for an image forming apparatus.

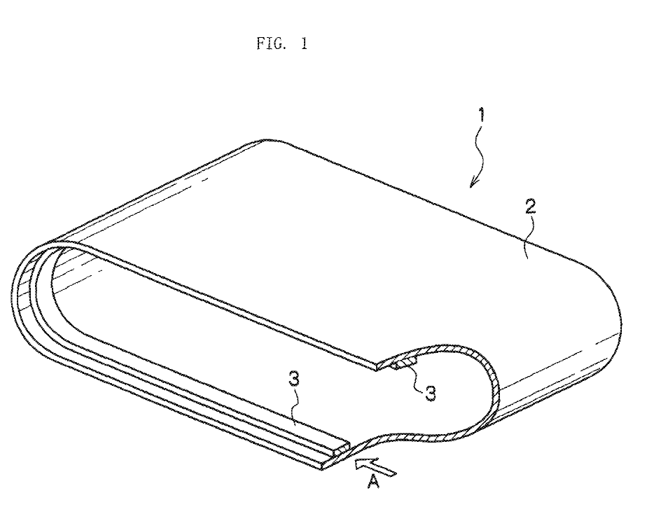

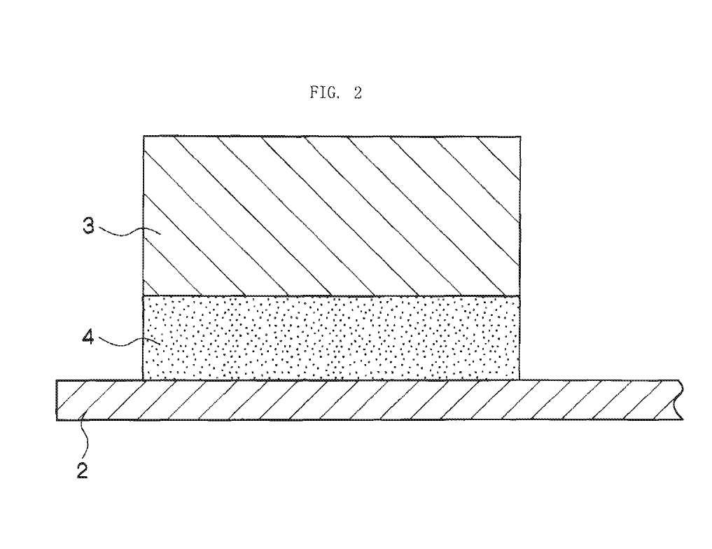

FIG. 1 is a perspective view showing the endless belt, provided with a convex member, of an image forming apparatus according to the first exemplary embodiment of the invention (part of the endless belt is shown sectionally). FIG. 2 is a cross sectional view of the belt body, the bonding portion and the convex member viewed in the direction of arrow A in FIG. 1.

The endless belt 1 for an image forming apparatus of the first exemplary embodiment of the invention shown in FIG. 1 has a belt body 2, and a convex member 3 formed along a side edge on the surface of the belt body 2. The convex member 3 is formed on the belt body 2 via a bonding portion 4 as shown in FIG. 2. While the convex member 3 is formed on the inner surface of the belt body 2 in FIG. 1, it may be formed on the outer surface of the belt body 2 depending on the use to which the endless belt 1 for an image forming apparatus is applied.

The T-type peel strength between the belt body 2 and the convex member 3 bonded via the bonding portion 4 is preferably equal to or about 0.4 N/mm or more in an environment of equal to or about 10° C. and equal to or about 15% RH, and is preferably equal to or about 0.8 N/mm or more in an environment of equal to or about 22° C. and equal to or about 55% RH.

The thrust type peel strength between the belt body 2 and the convex member 3 bonded via the bonding portion 4 is preferably from equal to or about 15 N/mm to equal to or about 25 N/mm in an environment of equal to or about 22° C. and equal to or about 55% RH.

Hereinafter, the belt body, the convex member and the bonding portion which are constituents of the endless belt for an image forming apparatus shown in FIGS. 1 and 2 will be described.

### Belt Body

When the endless belt 1 for an image forming apparatus according to the first exemplary embodiment of the invention shown in FIG. 1 is used, for example, for an intermediate transfer belt in an intermediate transfer apparatus or for a recording medium delivery belt of a delivery unit, the endless belt has a surface for holding a recording medium onto which a toner image is transferred, while the endless belt has a toner image holding surface on which the toner image is formed when the endless belt is used for a photosensitive belt in a photosensitive apparatus (in both cases, the surfaces correspond to the outer surface of the endless belt). In addition, the convex member 3 is formed along the side edge on the inner surface of the belt body 2 in the endless belt 1 for an image forming apparatus of the first exemplary embodiment of the invention.

A resin material having a Young's modulus of equal to or about 2,000 MPa or more is preferably used as the material of the belt body 2. While the larger the Young's modulus is the better, the Young's modulus is equal to or about 8,000 MPa or less, and preferably equal to or about 6,000 MPa or less from the practical point of view. The Young's modulus of the belt body 2 may be controlled within the above range by selecting the chemical structure of the resin materials to be used, and the Young's modulus may be further increased by using materials having aromatic structures.

The Young's modulus may be determined from the gradient of a tangent line drawn in an initial strain region of a stress-distortion curve obtained by a tensile test according to ISO 527-3 (1995). The measurement is performed under measurement conditions using a strip of a test piece (6 mm in width and 130 mm in length) and the load of a No. 1 dumbbell at a test speed of equal to or about 500 mm/minute, with respective settings for the thickness of the belt body.

The heat resistant temperature of the belt body 2 is preferably equal to or about 150° C. or more. The upper limit of the heat resistant temperature is equal to or about 400° C. due to the properties of the materials of the belt body.

Examples of the material used for the belt body 2 include polyimide resins, polyamideimide resins, polyester resins, polyamide resins and fluorinated resins, and the polyimide resins and polyamideimide resins are preferably used. The belt body may or may not have a junction, as long as it is circular (or endless), and the thickness of the belt body 2 is preferably from equal to or about 0.02 mm to equal to or about 0.2 mm.

When the endless belt 1 for an image forming apparatus shown in FIG. 1 is used, in particular, for an intermediate transfer belt or recording medium delivery belt in an image forming apparatus using an electrophotographic method, the belt body 2 is preferably a semi conductive belt using a polyimide resin including a conductive agent or a polyamideimide resin including a conductive agent. The term “semiconductive” as used herein refers to a state in which the volume resistance is from equal to or about 10⁷ Ω·cm to equal to or about 10¹³ Ω·cm.

The belt body 2 using the polyimide resin including the conductive agent may be produced, for example, by a known method of coating the inner surface of a cylindrical body with a polyimide precursor solution followed by drying, converting the precursor into an imide resin via a heating reaction, and peeling a polyimide resin film from the cylindrical core.

The belt body 2 using the polyamideimide resin including the conductive agent may be produced, for example, by a known method of coating the outer surface of a cylindrical body with a polyamideimide solution followed by drying by heating, and peeling a polyamideimide resin film from the cylindrical core.

When the endless belt 1 for an image forming apparatus shown in FIG. 1 is used for an intermediate transfer belt or paper delivery belt of an image forming apparatus, the surface resistance of the endless belt is preferably controlled in the range of from equal to or about 1×10⁹Ω/□ to equal to or about 1×10¹⁴Ω/□, and the volume resistance is controlled in the range of from equal to or about 1×10⁸ Ω·cm to equal to or about 1×10¹³ Ω·cm. Accordingly, carbon black such as ketjen black and acetylene black, graphite, metals such as aluminum, nickel and copper or metal alloys of these metals, metal oxides such as tin oxide, zinc oxide, potassium titanate, composite oxide of tin oxide-indium oxide or tin oxide-antimony oxide, or conductive polymers such as polyaniline, polypyrrole, polysulfone and polyacetylene may be preferably added as a conductive agent for the purpose described above. The term “conductivity” as used herein refers to a volume resistance of less than equal to or about 10⁷ Ω·cm. One of these conductive agents may be used alone, or a plurality of them may be used in combination.

The surface resistance and the volume resistance may be measured according to a known common test method for thermosetting plastics using a UR probe for HIRESTA UPMCO-450 (trade name: manufactured by Dia Instrument Co., Ltd.) at equal to or about 22° C. and equal to or about 55% RH.

### Convex Member

The convex member 3 is preferably an elastic member having a durometer hardness from equal to or about A60 to equal to or about A90, and particularly preferably from equal to or about A70 to equal to or about A90. The durometer hardness is defined as a hardness according to ISO 48 (1994), ISO 7619-1 (2004) and ISO 7619-2 (2004).

Examples of the material of the elastic member include elastic materials having an appropriate hardness such as polyurethane resins (polyurethane rubber), neoprene rubbers, polyurethane rubbers, silicone rubbers, polyester elastomers, chloroprene rubbers and nitrile rubbers. Polyurethane rubbers and silicone rubbers are particularly preferably used long these.

While the shape of the convex member 3 may be determined depending on the conditions of use of the endless belt 1 for an image forming apparatus, the cross section of the member is preferably substantially rectangular. While the width of the convex member 3 is not particularly restricted, it is usually from equal to or about 1 mm to equal to or about 10 mm, and particularly preferably from equal to or about 4 mm to equal to or about 7 mm. While the thickness is also not particularly restricted, it is usually from equal to or about 0.5 mm to equal to or about 5 mm, and particularly preferably from equal to or about 1 mm to equal to or about 2 mm.

### Bonding Portion

The “bonding portion” as used in the specification of the invention refers to a region where bodies to be bonded (that is, the belt body 2 and the convex member 3 in the endless belt 1 for an image forming apparatus shown in FIGS. 1 and 2) are bonded to one another by heating or pressurizing. The bodies to be bonded may be either bonded via an adhesive or a pressure-sensitive adhesive, or the bodies to be bonded may be directly bonded without intervention of an adhesive or a pressure-sensitive adhesive.

The “adhesive” as used herein refers to a material that exhibits a change of state from a solid to a liquid, from a liquid to a solid, or the like. The adhesive herein is different from the pressure-sensitive adhesive, which does not require a change of state for bonding.

The bonding portion 4 shown in FIG. 2 preferably has a glass transition temperature (Tg) of equal to or about −10° C. or less, and particularly preferably equal to or about −60° C. or less. While the lower limit of the glass transition temperature is not particularly restricted, the glass transition temperature (Tg) of a bonding portion that may generally be manufactured is equal to or about −100° C. or more.

The melting temperature (Tm) of the bonding portion is preferably from equal to or about 80° C. to equal to or about 140° C., and particularly preferably from equal to or about 100° C. to equal to or about 130° C.

The glass transition temperature (Tg) and the melting temperature (Tm) may be measured as follows using a differential scanning calorimeter (trade name: DSC-60, manufactured by Shimadzu Corporation).

For measuring the glass transition temperature (Tg), about 1 g of a sample is added to an aluminum crimp cell A1 (6 mm in diameter×1.5 mm in height), the sample cell is set in a liquid nitrogen cooling vessel to cool the sample at −140° C. using liquid nitrogen, the temperature of the sample is increased to 100° C. at a heating rate of 20° C./min, and a differential heat curve (endothermic curve) is obtained with reference to an empty aluminum crimp cell. The glass transition temperature (Tg) is determined from the inflection point of this endothermic curve.

For measuring the melting temperature (Tm), about 1 g of a sample is added to an aluminum crimp cell (6 mm in diameter×1.5 mm in height), the temperature of the sample is increased to 180° C. at a heating rate of 1° C./min, and a differential heat curve (exothermic curve) is obtained with reference to an empty aluminum crimp cell. The melting temperature (Tm) is determined from the inflection point of this exothermic curve.

For the measurement of the glass transition temperature (Tg) and the melting temperature (Tm) of the bonding portion 4, the same measurement is performed with respect to the adhesive or pressure-sensitive adhesive when the belt body 2 and the convex member 3 are bonded via the adhesive or pressure-sensitive adhesive, or the same measurement is performed with respect to the material of whichever of the belt body 2 or the convex member 3 are heated for bonding when the belt body 2 and the convex member 3 are directly bonded to one another.

The glass transition temperature (Tg) and the melting temperature (Tm) described in the specification of the invention are measured by the above methods.

The adhesive used for the bonding portion 4 shown in FIG. 2 is preferably a heat-sensitive adhesive that is a solid having no adhesive force at room temperature (from equal to or about 18° C. to equal to or about 28° C.), but exhibits an adhesive force by solidifying upon cooling after melting by heating. The adhesive is more preferably a thin film adhesive.

When the heat-sensitive thin film adhesive is used as the bonding portion 4, the thickness of the film is preferably from equal to or about 0.01 mm to equal to or about 0.5, and more preferably from equal to or about 0.02 mm to equal to or about 0.05 mm.

Examples of the adhesive include rubbers such as acrylic rubbers, polyester rubbers, silicone rubbers, natural rubbers, or synthetic rubbers, and synthetic resins such as urethane resins and vinyl chloride-vinyl acetate copolymers. Among these, adhesives of crystalline resins are preferably used, and a crystalline polyester adhesive is particularly preferably used. The term “crystalline resin” as used herein refers to a resin having a melting temperature peak when measured with a differential scanning calorimeter (heating rate: 20° C./min).

Specific examples of the crystalline polyester adhesive having a glass transition temperature of equal to or about −10° C. or less include GM-913, GM-920 and GA-6400 (trade names: all manufactured by Nisshinbo Industries Inc.).

The temperature for heating the adhesive used for the bonding portion 4 is preferably from equal to or about 80° C. to equal to or about 140° C., and more preferably from equal to or about 100° C. to equal to or about 130° C.

### Production of Endless Belt for Image Forming Apparatus

The endless belt 1 for an image forming apparatus may be produced by bonding a sheet of the belt body 2 and the convex member 3 via the bonding portion 4 followed by bonding both ends of the belt body 2 to one another, or by forming the belt body 2 into a circular belt followed by bonding the convex member 3 to the belt via the bonding portion 4. The convex member 3 may be provided along one side edge of the belt body 2, or convex members 3 may be provided along both side edges of the belt body 2. The bonding position (the distance from a side edge) at which a convex member 3 is bonded onto the belt body 2 may be determined depending on the use or function of the endless belt 1 for an image forming apparatus, the apparatus to which the endless belt 1 for an image forming apparatus is to be applied, or the like.

While the convex member 3 is bonded on the inner surface side of the belt body 2 in FIG. 1, it may be bonded onto the outer surface side of the belt body 2 depending on the use to which the endless belt 1 for an image forming apparatus is applied. The convex member 3 may be provided along the entire circumference of the endless belt 1 for an image forming apparatus, or a gap from equal to or about 1 mm to equal to or about 10 mm may be formed at the junction part of the convex member 3.

The method of bonding the convex member 3 on the belt body 2 is not particularly restricted. An example of the method is temporarily bonding a heat sensitive thin film adhesive having a sheet of release paper on one surface thereof on the convex member 3 at a temperature from equal to or about 60° C. to less than equal to or about 80° C., peeling the sheet of release paper, and bonding the convex member 3 and the belt body 2 via the adhesive by heating at a temperature from equal to or about 80° C. to equal to or about 140° C. The endless belt 1 for an image forming apparatus is produced by integrating the belt body 2 and the convex member 3 via the bonding portion 4.

Since it is important to bond the belt body and the convex member without allowing any air bubbles to exist between them, they are usually bonded with a hand roll, a rubber roll, a press machine or the like, or under reduced pressure or by pressurizing. The surface of the convex member 3 or the belt body 2 may be subjected to corona treatment, blast treatment, primer treatment, aging, or the like to improve bonding strength.

### T-Type Peel Strength

In the endless belt 1 for an image forming apparatus shown in FIGS. 1 and 2, the T-type peel strength between the belt body 2 and the convex member 3 bonded via the bonding portion 4 is preferably equal to or about 0.4 N/mm or more under low temperature and low humidity of 10° C. and 15% RH, and equal to or about 0.8 N/mm or more under atmospheric temperature and humidity of 22° C. and 55% RH. While the peel strength is not particularly restricted, the upper limit thereof is preferably equal to or about 2.0 N/mm or less.

The T-type peel strength may be controlled by controlling the bonding temperature of the bonding portion 4 in the production of the endless belt 1 for an image forming apparatus, and the higher the bonding temperature, the higher the T-type peel strength is. Particularly, a temperature range of from equal to or about 80° C. to equal to or about 140° C. is preferably used for controlling the T-type peel strength within the above-mentioned range.

The method of measuring the T-type peel strength will be described below.

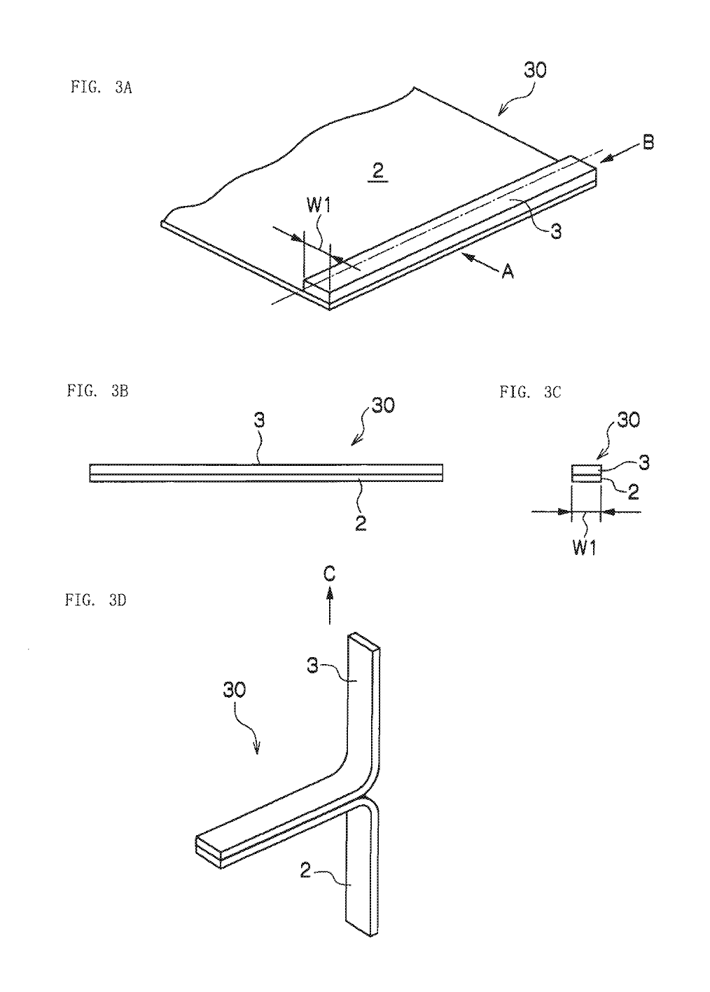

FIGS. 3A to 3D are explanatory diagrams illustrating the T-type peeling test. FIG. 3A shows a process of producing a test piece 30 for the T-type peeling test. FIGS. 3B and 3C show side views of the test piece 30. FIG. 3D illustrates the T-type peeling test method.

As shown in FIG. 3A, the test piece 30 having a width of W1 and a length of equal to or about 50 mm is obtained by cutting the belt body 2 with the same width as the width W1 of the convex member 3. FIG. 3B is a side view of the test piece 30 viewed along the direction of arrow A shown in FIG. 3A, and FIG. 3C is a side view of the test piece 30 viewed along the direction of arrow B shown in FIG. 3A.

Under an environment of 22±2° C. and 55±5% RH, one end of the obtained test piece 30 is peeled apart at a bonding interface between the belt body 2 and the convex member 3, one end of the belt body 2 is fixed, and the tensile force P1 (N) is measured when the convex member 3 is pulled to peel the convex member from the belt body 2 into a T-shape at a pulling rate of equal to or about 50 mm/min in the direction of arrow C. The T-type peel strength, that is, P1/W1 (N/mm) is calculated using the obtained values P1 and W1.

The T-type peeling test is carried out to measure the peel strength by applying a load in the direction of peeling the belt body 2 and the convex member 3 of the endless belt 1 for an image forming apparatus, and the peel strength may be used as an index of the strength against a load applied during delivery and storage of the endless belt 1 for an image forming apparatus.

### Thrust Peel Strength

The thrust peel strength between the belt body 2 and the convex member 3 bonded via the bonding portion 4 is preferably from equal to or about 15 N/mm to equal to or about 25 N/mm in an environment of the atmospheric temperature and humidity of 22° C. and 55% RH in the endless belt 1 for an image forming apparatus shown in FIGS. 1 and 2.

The thrust peel strength may be controlled according to the bonding temperature of the bonding portion 4 in the production process of the endless belt 1 for an image forming apparatus and the higher the bonding temperature the higher the thrust peel strength is. Particularly, a temperature range of from equal to or about 80° C. to equal to or about 140° C. is preferably used in order to ensure that the thrust peel strength is within the above-mentioned range.

The method of measuring the thrust peel strength will be described below.

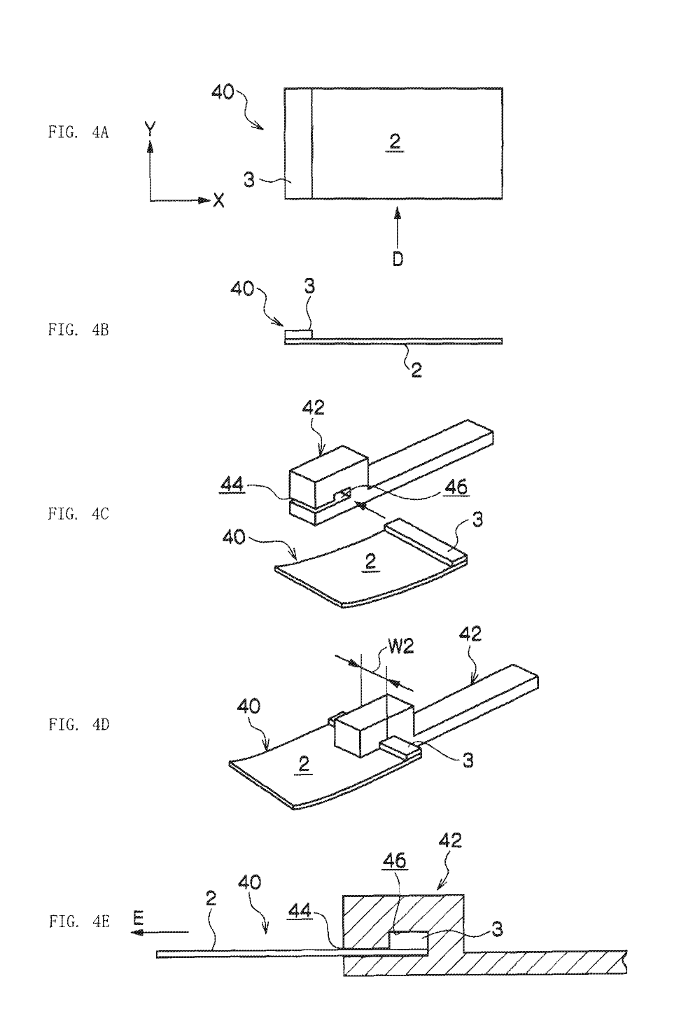

FIGS. 4A to 4E are explanatory diagrams illustrating the thrust peeling test method. FIG. 4A is a plane view showing a test piece 40, FIG. 4B is a side view of the test piece 40 viewed along the direction of arrow D in FIG. 4A. FIGS. 4C to 4E are explanatory diagrams illustrating the test method. FIG. 4C shows the test piece 40 before being inserted into a belt fixing member 42, FIG. 4D illustrates the test piece 40 after being inserted into the belt fixing member 42, and FIG. 4E is an enlarged longitudinal cross-sectional view of FIG. 4D.

As shown in FIG. 4A, the test piece 40 is prepared by cutting the endless belt for an image forming apparatus to have a width of 10 mm in the Y-direction and a length of 50 mm in the X-direction as shown in FIG. 4A. As shown in FIGS. 4C to 4E, the belt fixing member 412 used for the thrust peel strength test has a width W2 of 10 mm, and a belt body penetrating groove 44 and a convex member penetrating groove 46 are formed on the side face of the belt fixing member. A part of the belt body 2 and the convex member 3 of the test piece 40 are inserted into the belt member penetrating groove 44 and the convex member penetrating groove 46 provided on the side face of the fixing member 42 as shown in FIG. 4D. After inserting the test piece 40 in the belt fixing member 42, the test piece 40 is pulled in the direction of arrow 1E shown in FIG. 4E at a rate of 10 mm/min while the belt fixing member 42 is fixed in a secure state. A thrust force (shear force) is applied to the bonding portion between the belt body 2 and the convex member 3.

The force P2 (N) when the belt member 2 is peeled from the convex member 3 is measured under an environment of 22±2° C. and 55±5% RH, and the thrust peel strength, that is, P2/W2 (N/mm) is calculated from the measured value of P2(N) and the width W2 of the fixing member 42.

The peel strength when a load is applied in a vertical direction relative to the longitudinal direction of the convex member 3 provided on the endless belt 1 of an image forming apparatus is measured in the thrust peeling test. This value may be used as an index of the strength against a load when the endless belt 1 for an image forming apparatus is hung around belt supporting rolls during practical application of the endless belt 1 for an image forming apparatus.

### Image Forming Apparatus

The image forming apparatuses according to the second to fourth exemplary embodiments of the invention will be described with reference to drawings.

The image forming apparatuses according to the second to fourth exemplary embodiments of the invention are not particularly restricted as long as they use the endless belt for an image forming apparatus according to the first exemplary embodiment of the invention. In the image forming apparatuses, the endless belt for an image forming apparatus may be used, for example, as a paper delivery belt or an intermediate transfer belt as well as a photosensitive belt, a charging belt, a development belt, a fixing belt, or the like.

Examples of the aspect of the image forming apparatus include a normal monochromatic image forming apparatus that stores only a monochromatic toner in the development unit, a multicolor image forming apparatus in which primary transfer onto an intermediate transfer unit of a toner image held on an image holding unit of a photosensitive drum is sequentially repeated, and a tandem type multicolor image forming apparatus in which plural image holding units having development units for respective colors are arranged in series on the intermediate transfer unit.

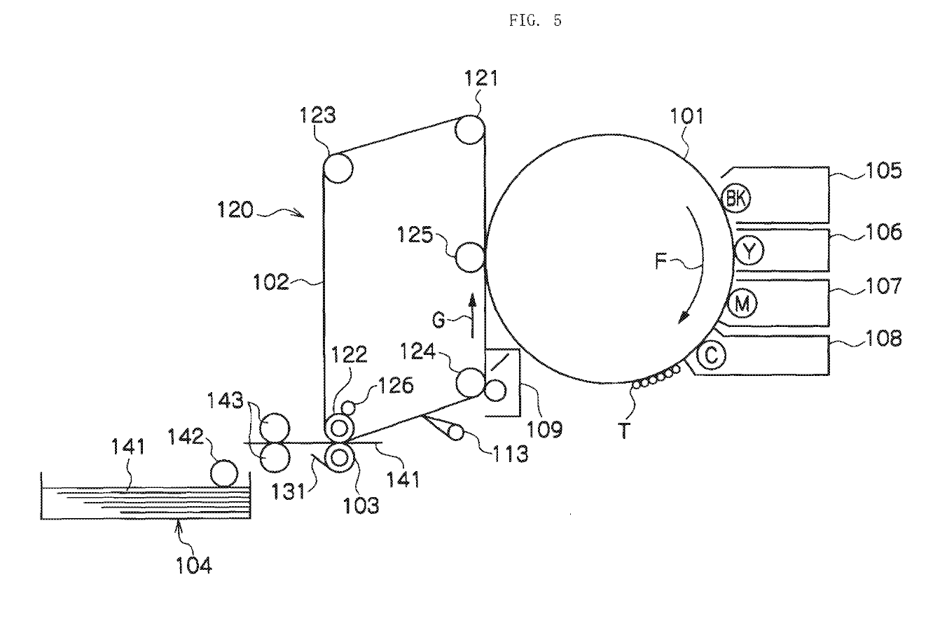

FIG. 5 is a schematic drawing of the image forming apparatus according to the second exemplary embodiment of the invention, having the endless belt for an image forming apparatus according to the first exemplary embodiment of the invention as an intermediate transfer belt.

The image forming apparatus according to the second exemplary embodiment shown in FIG. 5 has a development unit 105 using a BK (black) toner, a development unit 106 using an Y (yellow) toner, a development unit 107 using an M (magenta) toner and a development unit 108 using a C (cyan) toner on the surface of a photosensitive drum 101 that is an image holding unit. A primary transfer portion in contact with a conductive roll 125 via an intermediate transfer belt 102 that is an intermediate transfer unit is formed at the downstream side of the development unit 108, using the C (cyan) toner in the direction of rotation (the direction of arrow F) of the photosensitive drum 101. The term “conductive roll” as used herein refers to a roll having a volume resistance of less than equal to or about 10⁷ Ω·cm.

The intermediate transfer belt 102 is rotatably suspended in a tensioned state by receiving tension from belt supporting rolls 121, 123 and 124 and a back-up roll 122 from the inner surface side of the belt, to configure a belt suspending apparatus 120 for an image forming apparatus.

A bias roll 103 is provided at a position opposing the back-up roll 122 via the intermediate transfer belt 102 to form a secondary transfer portion. A cleaning blade 13 is disposed in contact with the bias roll 103, and an electrode roll 126 is disposed in contact with the back-up roll 122. Paper sheets 141 as recording media are stored in a paper feed unit 104, where a pick-up roll 142 for delivering a paper sheet from the paper sheets 141 and paper feed rolls 143 for feeding the paper sheet to the secondary transfer portion at a given timing are provided. A peeling pawl 113 for peeling away the paper sheet onto which an image is transferred in the secondary transfer portion is disposed so as to be freely contactable with and detachable from the intermediate transfer belt 102 at the downstream side in the direction of rotation (the direction of arrow G) from the secondary transfer portion of the intermediate transfer belt 102, and a belt cleaning member 109 for cleaning the belt by removing residual toners after the transfer is disposed at the downstream side of the peeling pawl.

The photosensitive drum 101 rotates in the direction of arrow F in the image forming apparatus according to the second exemplary embodiment of the invention shown in FIG. 5, and the surface of the drum is charged by a charging unit (not shown). An electrostatic latent image of a first color (for example black (BK)) is formed on the photosensitive drum 101 by an image writing device such as a laser writing device. This electrostatic latent image is formed into a visualized toner image T by toner-development with the development unit 105. The toner image T arrives by means of rotation of the photosensitive drum 101 at the primary transfer portion where the conductive roll 125 is disposed, the toner image T is electrostatically adsorbed onto the intermediate transfer belt 102 by means of an electric field of polarity opposite to that of the toner image T, which is applied from the conductive roll 125, and a primary transferred image is formed by the rotation of the intermediate transfer belt 102 in the direction of arrow G. The conductive roll 125 may be disposed immediately under the photosensitive drum 101 as shown in FIG. 5, or may be disposed at a position displaced from the position immediately under the photosensitive drum 101.

Subsequently, a multicolor toner image is formed by allowing a toner image of a second color, a toner image of a third color and a toner image of a fourth color to be sequentially overlapped on the toner image of the first color by the above-mentioned method. Each toner may be either a one-component toner or a two-component toner.

The multicolor toner image transferred onto the intermediate transfer belt 102 arrives by the rotation of the intermediate transfer belt 102 at a secondary transfer portion at which the bias roll 103 is disposed. The secondary transfer portion is composed of the bias roll 103 provided at the surface side of the intermediate transfer belt 102 on which the toner image is retained, the back-up roll 122 disposed so as to oppose the bias roll 103 from the back surface side of the intermediate transfer belt 102, and the electrode roll 126 that rotates in pressure-contact with the back-up roll 122.

Paper sheets 141 are fed out from a bundle of paper stored in the paper feed unit 104 by the pick-tip roll 142 one by one, and are delivered and supplied by the paper feed rolls 143 to a contact area formed by the intermediate transfer belt 102 and the bias roll 103 of the secondary transfer portion at a given timing. The toner image held on the intermediate transfer belt 102 is transferred onto the supplied paper sheet 141 by pressure-contact delivery with the bias roll 103 and the back-up roll 122 and by the rotation of the intermediate transfer belt 102.

The paper sheet 141 onto which the toner image is transferred is peeled from the intermediate transfer belt 102 by actuating the peeling pawl 113 that has existed at a withdrawal position until primary transfer of a final toner image has been completed. The paper sheet onto which the toner image is transferred is then delivered to a fixing unit (not shown), and the toner image on the paper sheet is turned into a permanent image by fixing the toner image by at least one of pressurizing and heating treatment. Residual toner is removed from the intermediate transfer belt 102 with the belt cleaning member 109 provided at the downstream side of the secondary transfer region after the transfer of the multicolor image onto the paper sheet 141 is completed, to make the intermediate transfer belt ready for subsequent transfer. The bias roll 103 is mounted with a cleaning blade 131 made of polyurethane that is in contact therewith, and foreign substances such as toner particles and paper powder adhered during the transfer are removed.

While the toner image T of the primary transfer is directly transferred onto the paper sheet 141 and is delivered to the fixing unit when the image is a monochromatic image, rotation of the intermediate transfer belt 102 is synchronized with rotation of the photosensitive drum 101 so that the toners of respective colors are precisely over lapped at the primary transfer portion in order to avoid the toner images of respective colors from being displaced when a multicolor image is transferred by overlapping plural colors. The toner image is transferred onto the paper sheet 141 by electrostatic repulsion at the secondary transfer portion by impressing an output voltage (transfer voltage) having the same polarity as the polarity of the toner image to the electrode roll 126 that is in pressure-contact with the back-up roll 122, which faces the bias roll 103 via interposition of the intermediate transfer belt 112.

The image is formed as described above.

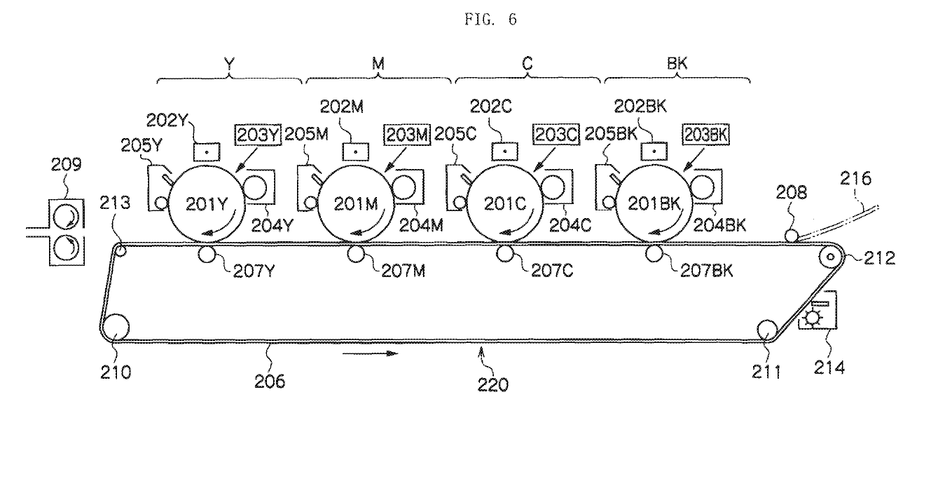

FIG. 6 is a schematic drawing showing an image forming apparatus of the third exemplary embodiment of the invention, having the endless belt for an image forming apparatus according to the first exemplary embodiment as a paper sheet delivery belt.

In the image forming apparatus according to the third exemplary embodiment of the invention shown in FIG. 6, units Y, M, C and BK are provided with photosensitive drums 201Y, 201M, 201C and 201BK, respectively, which are rotatable with a given circumferential speed (process speed) in the clockwise direction shown by arrows. Charging rolls 202Y, 202M, 202C and 202BK, exposure devices 203Y, 203M, 203C, and 203BK, development units of respective colors (yellow color development unit 204Y, magenta color development unit 204M, cyan color development unit 204C and black color development unit 204BK), and photosensitive drum cleaning members 205Y, 205M, 205C and 205BK are respectively disposed around the photosensitive drums 201Y, 201M, 201C and 201BK.

The four units BK, M, C and BK are aligned in parallel to the rotation of the paper sheet delivery belt 206 in the order of the units BK, C, M and Y. However, appropriate orders of the units BK, Y, C, M may be determined depending on the image forming method.

The paper sheet delivery belt 206 is suspended in a tensioned state by the belt supporting rolls 210, 211, 212 and 213 from the inner face side of the belt to form a belt suspending apparatus 220 for an image forming apparatus. The paper sheet delivery belt 206 is rotatable at the same circumferential speed as the photosensitive drums 201Y, 201M, 201C and 201BK in the counter-clockwise direction as shown by arrows in FIG. 6, and photosensitive drums 201Y, 201M, 201C and 201BK are disposed so as to be in contact with the paper sheet delivery belt at respective intermediate positions of the belt between the belt supporting rolls 212 and 213. A belt cleaning member 214 is provided at the paper sheet delivery belt 206.

Transfer rolls 207N; 207M, 207C and 207BK are provided at the inner surface side of the paper sheet delivery belt 206, and are disposed at the portions opposing the positions where the paper sheet delivery belt 206 is brought in contact with the photosensitive drums 201Y, 201M, 201C and 201BK, respectively. The transfer rolls and the photosensitive drums 201Y, 201M, 201C and 201BK form respective transfer portions for transferring the image onto the paper sheet (transfer object) 216 via the paper sheet delivery belt 206. As shown in FIG. 6, the transfer rolls 207Y, 207M, 207C and 207BK may be disposed directly under the corresponding photosensitive drums 201Y, 201M, 201C and 201BK, or the positions thereof may be displaced from the position directly under each photosensitive drum.

A fixing unit 209 is disposed so that the paper sheet is delivered thereto after the paper sheet passes through the respective transfer portions between the paper sheet delivery belt 206 and the photosensitive drums 201Y, 201M, 201C and 201BK.

The paper sheet 216 is delivered onto the paper sheet delivery belt 206 by means of a paper sheet delivery roll 208.

The photosensitive drum 201BK is rotated at the BK unit in the image forming apparatus according to the third exemplary embodiment of the invention shown in FIG. 6. The charging roll 202BK operates concomitantly with the photosensitive drum, and the surface of the photosensitive drum 201BK is charged with a given polarity and voltage. The photosensitive drum 201BK having the charged surface is imagewise exposed to light with the exposure device 203BK, and an electrostatic latent image is formed on the surface.

Subsequently, the electrostatic latent image is developed with the black color development unit 204BK. Then, a toner image is formed on the surface of the photosensitive drum 201BK. The developer used in this process may be either a one-component developer or a two-component developer.

The toner image passes through the transfer portion between the photosensitive drum 201BK and the paper sheet delivery belt 206, the paper sheet 216 is delivered to the transfer portion by being electrostatically adsorbed onto the delivery belt 206, and the images are sequentially transferred onto the surface of the paper sheet 216 by an electric field formed by a transfer bias imposed from the transfer roll 207BK.

After that, residual toner on the photosensitive drum 201BK is cleaned and removed with the photosensitive drum cleaning member 205BK. Thus, the photosensitive drum 201BK is ready for subsequent transfer of an image.

The image transfer is also carried out at the units C, M and Y by the same method as described above.

The paper sheet 216 onto which the toner image is transferred with the transfer rolls 207BK, 207C, 207M and 207Y is delivered to the fixing unit 209, and the image is fixed.

A desired image is thus formed.

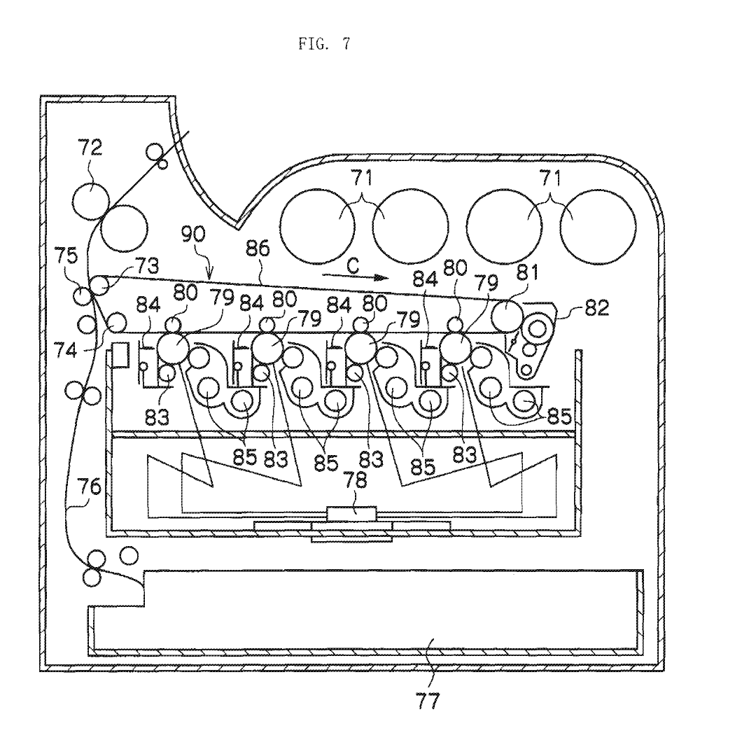

FIG. 7 is a schematic drawing illustrating the main part of a tandem-type image forming apparatus according to the fourth exemplary embodiment of the invention, having the endless belt for an image forming apparatus according to the first exemplary embodiment as an intermediate transfer belt.

Specifically, the apparatus may optionally include, as in the related art: a charging roll (charging unit) 83 for charging the surface of a photosensitive body 79; a laser generator (exposure unit) 78 for exposing the surface of the photosensitive body 79 to light to form an electrostatic latent image; a development unit (development device) 85 for forming a toner image by developing the latent image formed on the surface of the photosensitive body 79 with a developer; a transfer roll 80 for transferring the developed toner image onto an intermediate transfer belt 86; a photosensitive body cleaning member (cleaning unlit) 84 for removing toner and dust adhered to the photosensitive body 79; and a fixing roll 72 for fixing the toner image onto a material onto which the image is to bee fixed. The transfer roll 80 may be disposed immediately above the photosensitive body 79 as shown in FIG. 7, or the photosensitive body 79 may be disposed at a position displaced from the position immediately above the photosensitive body 79.

The configuration of the image forming apparatus according to the fourth exemplary embodiment of the invention shown in FIG. 7 will be described in further detail.

In the image forming apparatus according to the fourth exemplary embodiment of the invention, the charging roll 83, the development unit 85, the primary transfer roll 80 disposed via the intermediate transfer belt 86 and the photosensitive body cleaning member 84 are aligned around the photosensitive body 79 in a counter-clockwise direction, and this group of members are configured as a development unit corresponding to one color. A toner cartridge 71 for supplying the development unit 85 with a developer is provided for each development unit, and the laser generator 78 that is able to radiate a laser light according to image information onto the surface of the photosensitive body 79 located at the down stream side (in the direction of rotation of the photosensitive body 79) of the charging roll 83 and at the upstream side of the development unit 85, is provided for the photosensitive body 79 of each development unit.

Four development units corresponding to four colors (for example cyan, magenta, yellow and black), respectively, are aligned in series in the horizontal direction in the image forming apparatus, and the intermediate transfer belt 86 is provided so as to pass through the transfer portions between the photosensitive bodies 79 and the primary transfer rolls 80 in the four development units. The intermediate transfer belt 86 is suspended in a tensioned state with a supporting roll 73, a suspending roll 74 and a driving roll 81 provided at the inner surface side of the belt in this order in the counter-clockwise direction, and these members configure a belt suspending apparatus 90 for an image forming apparatus. Four primary transfer rolls are located at the downstream side (in the direction of rotation of the intermediate transfer belt 86) of the supporting roll 73 and at the upstream of the suspending roll 74. A transfer cleaning member 82 for cleaning the external circumferential surface of the intermediate transfer belt 86 is provided at the opposite side of the driving roll 81 via the intermediate transfer belt 86 so as to be brought into pressure-contact with the driving roll 81.

A secondary transfer roll 75, which is provided for transferring the toner image formed on the external circumferential surface of the intermediate transfer belt 86 onto the surface of a recording paper sheet delivered from a paper sheet feed unit 77 along a paper path 76, is provided at the opposite side of the support roll 73 via the intermediate transfer belt 86 so as to be brought into pressure-contact with the supporting roll 73.

A paper sheet feed unit 77 for storing the recording paper sheet is provided at the bottom of the image forming apparatus, and the paper sheet is supplied from the paper sheet feed unit 77 along the paper path 76 so that the paper sheet passes through the pressure-contacting part between the support roll 73 and the secondary transfer roll 75, which configure a secondary transfer portion. The recording paper sheet after passing through the pressure-contacting part may be delivered by a delivery device (not shown) so that the paper sheet is further inserted between and passes through a pair of fixing rolls 72, and is finally ejected out of the image forming apparatus.

Next, the image forming method using the image forming apparatus according to the fourth exemplary embodiment of the invention shown in FIG. 7 will be described. A toner image is formed at each development unit. The surface of the photosensitive body 79, which rotates in the counter-clockwise direction, is charged with the charging roll 83, and a latent image is then formed on the surface of the photosensitive body 79 that has been charged with the laser generator 78 (exposure unit). Then, a toner image is formed by developing the latent image with a developer supplied from the development unit 85, and the toner image is delivered to the pressure-contacting part between the primary transfer roll 80 and the photosensitive body 79 is transferred onto the external circumferential surface of the intermediate transfer belt 86 rotating in the direction of arrow C. Toner and dust adhered to the surface of the photosensitive body 79 are cleaned with the photosensitive body cleaning member 84 after the transfer of the toner image, and the photosensitive body is ready for forming subsequent toner images.

Toner images of each color developed at every developing unit are successively superimposed on the external circumferential surface of the intermediate transfer belt 86 so as to correspond to image information, and are delivered thus by the secondary transfer roll 75 to the secondary transfer portion where they are transferred onto a surface of a recording paper sheet delivered from the paper feed unit 77 along paper path 6. The toner image transferred onto the recording paper sheet is further fixed by heating the recording paper sheet under pressure upon passing it through a pressure-contacting part of the pair of the fixing rolls 72 constituting a fixing portion and, after formation of an image on a recording medium surface, the recording medium is discharged outside the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### EXAMPLES

While the endless belt for an image forming apparatus according to the first exemplary embodiment of the invention is described in more detail with reference to examples, the present invention is not restricted to the examples as set forth below.

### Example 1

### Production of Endless Belt for Image Forming Apparatus

FIG. 1 is a schematic configurational view of an example of the endless belt for an image forming apparatus according to the first exemplary embodiment of the invention.

In FIG. 1, the endless belt for an image forming apparatus has a belt body 2 and a convex member 3 bonded at the edge of the belt body 2, and the belt is rotatably supported with belt supporting rolls (not shown).

The belt body 2 (base material) is produced as follows.

### Preparation of Polyimide Base Material (I)

An N-methyl-2-pyrrolidone (NPM) solution of a polyamide acid composed of 3,3′,4,4′-biphenyl tetracarboxylic acid anhydride (BPDA) and 4,4′-diaminodiphenylether (DDE) (trade name: U-VARNISH S (solid content of 18% by mass), manufactured by Ube Industries, Ltd.) is used. 23 parts by mass of dry oxidized carbon black (trade name: SPECIAL BLACK 4, manufactured by Evonik Degussa, pH 3.0, volatile content of 14.0%) is added to 100 parts by mass of the solid content of a component capable of forming a polyimide resin in the solution, and carbon black is mixed by dividing the solution into two parts and causing the two parts to collide at a minimum area of equal to or about 1.4 mm² at a pressure of equal to or about 200 MPa using a collision disperser (trade name: GEANUS PY, manufactured by Geanus Co.), followed by allowing the solution to pass through a two division flow pathway five times, to obtain a polyamide acid solution (A) for the base material including carbon black.

The polyamide acid solution (A) including carbon black is applied onto the inner surface of a cylindrical die by means of a dispenser so that the thickness of the coating film is equal to or about 0.5 mm. After forming the coating film by rotating the die at equal to or about 1,500 rpm for equal to or about 15 minutes, hot air at equal to or about 60° C. is blown for equal to or about 30 minutes from the outside of the die while the die is rotated at equal to or about 250 rpm, and the die is cooled to room temperature (equal to or about 22° C.) after heating it at equal to or about 150° C. for equal to or about 60 minutes.

After that, the coating film formed on the inner surface of the die is peeled. The coating film is used to cover the external circumference of the metal core, and the metal core is heated to equal to or about 400° C. with a heating rate of equal to or about 2° C./minute. The metal core is further heated at equal to or about 400° C. for equal to or about 30 minutes to remove from the film residual solvent and water produced by ring closure due to dehydration, and an imide-conversion reaction is thus completed. The metal core is cooled to room temperature (equal to or about 22° C.), and a belt body (polyimide base material (I)) with a thickness of equal to or about 0.08 mm is obtained by peeling the polyimide thin film formed on the surface of the metal core. The polyimide base material (I) has a surface resistance of equal to or about 1×10¹²Ω/□, a volume resistance of equal to or about 3.2×10⁹ Ω/cm and a Young's modulus of equal to or about 3,800 MPa.

### Preparation of Polyamideimide Base Material (II)

A solvent-soluble polyamideimide resin (trade name: BIROMAX HR16NN (solid content of 18% by mass, solvent: methyl-2-pyrrolidone), manufactured by Toyobo Co., Ltd.) as a polyamideimide resin is used. Carbon black (trade name: SPECIAL BLACK 4 (pH 3, volatile fraction: 14% by mass), manufactured by Degussa Co.) is added as a conductive agent in an amount of 25 parts by mass with respect to 100 parts by mass of the resin component, to obtain a solution. Carbon black is dispersed by allowing the solution to pass through an orifice with a diameter of equal to or about φ0.1 mm at equal to or about 150 MPa using a high pressure disperser (manufactured by Geanus Co.) followed by allowing slurries divided into two parts to collide five times. This solution is applied onto the outer surface of an aluminum pipe with an outer diameter of equal to or about 168 mm. After drying the coating film at equal to or about 150° C. for equal to or about 30 minutes, it is heated at equal to or about 250° C. for equal to or about 1 hour, to thereby obtain a belt body (polyamideimide base material (II)) having an outer diameter of equal to or about 168 mm and a width of equal to or about 368 mm. This polyamideimide base material (II) has a surface resistance of equal to or about 1.1×10¹²Ω/□.

### Bonding of Convex Member

Convex members are provided for the polyimide base material (I) and the polyamideimide base material (II) by the following method. A thermosetting urethane rubber sheet having a durometer hardness of equal to or about 70 and a thickness of equal to or about 1 mm (trade name: TIPRENNE TR100-70, manufactured by Tigers Polymer Co.) is cut into a sheet having a width of equal to or about 5 mm and used as the convex member 3.

The bonding surface of the thermosetting urethane rubber having a thickness of equal to or about 1 mm and a width of equal to or about 5 mm is subjected to blast treatment in advance. After temporarily bonding a heat-sensitive thin film adhesive of crystalline polyester (trade name: GM-193, manufactured by Nisshinbo Industries Inc.) on the surface of a sheet of release paper by heating and pressurizing at a temperature of equal to or about 75° C. for equal to or about 10 seconds under a pressure of equal to or about 34.2 N/cm², the release paper having a thickness of equal to or about 127 μm is peeled away, and the adhesive is bonded onto the back surface of the endless belt by heating and pressurizing for equal to or about 20 seconds at equal to or about 120° C. under a pressure of equal to or about 34.2 N/cm², to thereby produce the endless belt for an image forming apparatus.

The endless belt for an image forming apparatus of Example 1 thus obtained is evaluated as follows.

### T-Type Peel Strength Test

The T-type peel strength test is performed as described above. The test machine used is a precise load tester (trade name: MODEL-1605N, manufactured by Nihon Denkei Co., Ltd.). The strength is evaluated by five instances of tests (N=5), and the minimum value obtained in the tests is used as the strength. W1 is equal to or about 5 mm in this test.

In the following Table 1, an environment of atmospheric temperature and humidity (22° C./55% RH) is defined as “environment B”, and an environment of low temperature and low humidity (10° C. and 15% RH) is defined as “environment C”.

### Thrust Peel Strength Test

The thrust peel strength test is performed as described above. The test machine used is the precise load tester MODEL-1605N described above.

### Belt Lifetime

The belt lifetime is determined by the number of rotations of the endless belt for an image forming apparatus until the convex member is peeled therefrom. The endless belt for an image forming apparatus is driven so that the endless belt for an image forming apparatus is always biased by allowing alignment of the axis to be displaced by equal to or about 1 mm for every rotation using a DC 1250 (trade name: manufactured by Fuji Xerox Co.). One turn of the belt is counted as 1 cycle. Evaluation criteria of the lifetime of the belt are as follows.

A: Equal to or about 2,000,000 cycles or more,

B: From equal to or about 1,600,000 cycles to less than equal to or about 2,000,000 cycles.

C: Less than equal to or about 1,600,000 cycles.

### Total Evaluation

The belt is comprehensively evaluated by the evaluations of the T-type peel strength test, the thrust peel strength test and the belt lifetime in accordance with the following criteria.

A: No problems in the belt lifetime and the storage characteristics (that is, T-type peel strength test and thrust peel strength test).

B: While there is no problem in the belt lifetime, storage characteristics are problematic.

C: Both of the belt lifetime and the storage characteristics are problematic.

### Example 2

An endless belt for an image forming apparatus is produced and evaluated by the sane methods as in Example 1 except that the adhesive GM-913 (described above) as the crystalline polyester heat-sensitive thin film used for bonding of the convex member in Example 1 is exchanged with an adhesive GM-920 (trade name, manufactured by Nisshinbo Industries Inc.) as a crystalline polyester heat sensitive thin film, and the bonding conditions (heating temperature and heating time) of the adhesive are changed as described in Table 1.

### Example 3

An endless belt for an image forming apparatus is produced and evaluated by the same method as in Example 1 except that the adhesive GM-913 (described above) as the crystal line polyester heat-sensitive thin film used for bonding of the convex member in Example 1 is exchanged with an adhesive GA-6400 (trade name, manufactured by Nisshinbo Industries Inc.) as a crystalline polyester heat sensitive thin film, and the bonding conditions (heating temperature and heating time) of the adhesive are changed as described in Table 1.

### Comparative Example 1

An endless belt for an image forming apparatus is produced and evaluated by the same method as in Example 1 except that the adhesive GM-913 (described above) as the crystalline polyester heat-sensitive thin film used for bonding of the convex member in Example 1 is exchanged with an adhesive D-3600 (trade name, manufactured by Sony Chemical & Information Device Corporation) as a crystalline polyester heat sensitive thin film, and the bonding conditions (heating temperature and heating time) of the adhesive are changed as described in Table 1.

### Comparative Example 2

An endless belt for an image forming apparatus is produced and evaluated by the same method as in Example 1 except that the adhesive GM-913 (described above) as the crystalline polyester heat-sensitive thin film used for bonding of the convex member in Example 1 is exchanged with an adhesive 6501 (trade name, manufactured by Daicel Chemical Industries, Ltd.) as a urethane heat sensitive thin film, and the bonding conditions (heating temperature and heating time) of the adhesive are changed as described in Table 1.

### Comparative Example 3

An endless belt for an image forming apparatus is produced and evaluated by the same method as in Example 1 except that the adhesive CM-913 (described above) as the crystalline polyester heat-sensitive thin film used for bonding of the convex member in Example 1 is exchanged with an adhesive 2401 (trade name, manufactured by Daicel Chemical Industries, Ltd.) as a polyamide heat sensitive thin film, and the bonding conditions (heating temperature and heating time) of the adhesive are changed as described in Table 1.

### Comparative Example 4

An endless belt for an image forming apparatus is produced and evaluated by the same method as in Example 1 except that the adhesive GM-913 (described above) as the crystalline polyester heat-sensitive thin film used for bonding of the convex member in Example 1 is exchanged with an adhesive 5015 (trade name, manufactured by Nitto Denko Co.) as an acrylic heat sensitive thin film, and the bonding conditions (heating temperature and heating time) of the adhesive are changed as described in Table 1.

The results of the evaluation are shown in Table 1. In Table 1, “PAI” denotes an endless belt for an image forming apparatus using polyamideimide as the base material, and “PI” denotes an endless belt for an image forming apparatus using polyimide as the base material.

TABLE 1

| | | | | | | Comparative | Comparative | Comparative | Comparative |
|---|---|---|---|---|---|---|---|---|---|
| | | | Example 1 | Example 2 | Example 3 | Example 1 | Example 2 | Example 3 | Example 4 |
| Adhesive | | | GM-913 | GM-920 | GA-6400 | D3600 | Adhesive | Adhesive | Adhesive |
| | | | | | | | 6501 | 2401 | 5015 |
| Main | | | Crystalline | Crystalline | Crystalline | Crystalline | | | |
| component | | | polyester | polyester | polyester | polyester | Urethane | Polyamide | Acrylic resin |
| Thermal | Tg (° C.) | | −70 | −60 | −20 | 16 | −5 | 28 | 70 |
| characteristics | Tm (° C.) | | 126 | 107 | 86 | 165 | 180 | 230 | 265 |
| Bonding | Heating temperature | | 120 | 100 | 90 | 120 | 120 | 150 | 120 |
| condition | (° C.) | | | | | | | | |
| | Heating time (sec) | | 20 | 20 | 20 | 20 | 20 | 20 | 20 |
| T-type peel | PAI | Environment B | 1.26 | 1.22 | 0.92 | 1.3 | 0.75 | 0.6 | 0.3 |
| strength | | Environment C | 1.9 | 1.4 | 1.2 | 0.36 | 0.42 | 0.06 | 0.36 |
| (N/mm) | PI | Environment B | 1.25 | 1.21 | 0.9 | 1.28 | 0.65 | 0.48 | 0.18 |
| | | Environment C | 0.62 | 0.6 | 0.5 | 0.32 | 0.34 | 0.24 | 0.16 |
| Thrust peel | PAI | Environment B | 15.9 | 15.5 | 15.2 | 16 | 11.2 | 6.9 | 5 |
| strength | PI | Environment B | 16.2 | 15.8 | 15.1 | 16 | 10 | 6.9 | 4.8 |
| (N/mm) | | | | | | | | | |

| | | | | | | | |
|---|---|---|---|---|---|---|---|
| Belt lifetime | A | A | A | B | C | C | C |
| Total evaluation | A | A | A | B | C | C | C |

Preferable embodiments of the present invention will be shown below.

(1) According to an aspect of the invention, there is provided an endless belt for an image forming apparatus including: a belt body; a convex member; and a bonding portion for bonding the belt body and the convex member, the bonding portion having, a glass transition temperature (Tg) of equal to or about −10° C. or less. In the endless belt so configured as described above, good adhesiveness between the belt body and the convex member even wider changes in environmental conditions may be obtained, as compared with an endless belt in which the glass transition temperature of the bonding portion is not considered.

(2) According to another aspect of the invention, in the endless belt for an image forming apparatus of item (1), the glass transition temperature (Tg) is equal to or about −60° C. or less. In the endless belt so configured as described above, better adhesiveness between the belt body and the convex member even under changes in environmental conditions may be obtained, as compared with an endless belt in which the glass transition temperature of the bonding portion is not considered.

(3) According to another aspect of the invention, in the endless belt for an image forming apparatus of item (1) or (2), the melting temperature (Tm) of the bonding portion is from equal to or about 80° C. to equal to or about 140° C. In the endless belt so configured as described above, good adhesiveness may be obtained while the endless belt is favorably prevented from being deteriorated by heating for bonding, as compared with an endless belt in which the melting temperature of the bonding portion is not considered.

(4) According to another aspect of the invention, in the endless belt for an image forming apparatus of item (1) or (2), the melting temperature (Tm) of the bonding portion is from equal to or about 100° C. to equal to or about 130° C. In the endless belt so configured as described above, good adhesiveness may be obtained while the endless belt is favorably prevented from being deteriorated by heating for bonding, as compared with an endless belt in which the melting temperature of the bonding portion is not considered.

(5) According to another aspect of the invention, in the endless belt for an image forming apparatus of any one of items (1) to (4), the bonding portion includes a crystalline resin. In the endless belt so configured as described above, good adhesiveness may be obtained as compared with an endless belt in which crystallinity of the resin contained in the bonding portion is not considered.

(6) According to another aspect of the invention, in the endless belt for an image forming apparatus of item (5), the crystalline resin is crystalline polyester. In the endless belt so configured as described above, good adhesiveness may be obtained as compared with an endless belt in which crystallinity of the resin contained in the bonding portion is not considered.

(7) According to another aspect of the invention, in the endless belt for an image forming apparatus of any one of items (1) to (6), the T-type peel strength between the belt body and the convex member is equal to or about 0.4 N/mm or more under an environment of 10° C. and 15% RH. The durability of the endless belt so configured as described above may be improved under a low temperature and low humidity environment.

(8) According to another aspect of the invention, in the endless belt for an image forming apparatus of any one of items (1) to (7), the T-type peel strength between the belt body and the convex member is equal to or about 0.8 N/mm or more, and the thrust peel strength between the belt body and convex member is from equal to or about 15 N/mm to equal to or about 25 N/mm under an environment of 22° C. and 55% RH. The durability of the endless belt so configured as described above may be improved under atmospheric temperature and atmospheric humidity environment.

(9) According to another aspect of the invention, in the endless belt for an image forming apparatus of any one of items (11) to (8), the belt body has a heat resistant temperature of from about 150° C. to about 400° C. The endless belt so configured as described above may be favorably prevented from being deteriorated by heating for bonding.

(10) According to another aspect of the invention, in the endless belt for an image forming apparatus of any one of items (1) to (9), the belt body of the endless belt for an image forming apparatus includes at least one selected from a polyimide resin and a polyamideimide resin. The endless belt so configured as described above is able to obtain good drivability even under an environment in which a large load is applied thereto.

(11) According to another aspect of the invention, there is provided a belt suspending apparatus for an image forming apparatus, including: the endless belt for an image forming apparatus according to any one of items (1) to (10); and a plurality of suspending members for suspending the endless belt rotatably in a tensioned state from the inner surface side of the endless belt. Breakage of the endless belt configured as described above is suppressed and the mechanical lifetime may be prolonged as compared with an endless belt in which the glass transition temperature of the bonding portion is not considered.

(12) According to another aspect of the invention, there is provided an image forming apparatus, including the endless belt for an image forming apparatus according to any one of items (1) to (10). In the image forming apparatus configured as described above good adhesiveness between the belt body and the convex member even under changes in environmental conditions may be obtained such that image defects may be favorably suppressed, as compared with an image forming apparatus having an endless belt in which the glass transition temperature of the bonding portion is not considered.

1. An endless belt for an image forming apparatus, comprising:
a belt body;
a convex member; and
a bonding portion for bonding the belt body and the convex member, the bonding portion having a glass transition temperature (Tg) of about -10 C. or less.

2. The endless belt for an image forming apparatus of claim 1, wherein the glass transition temperature (Tg) is about -60° C. or less.

3. The endless belt for an image forming apparatus of claim 1, wherein the melting temperature (Tm) of the bonding portion is from about 80° C. to about 140° C.

4. The endless belt for an image forming apparatus of claim 1, wherein the melting temperature (Tm) of the bonding portion is from about 100° C. to about 130° C.

5. The endless belt for an image forming apparatus of claim 1, wherein the bonding portion comprises a crystalline resin.

6. The endless belt for an image forming apparatus of claim 5, wherein the crystalline resin is crystalline polyester.

7. The endless belt for an image forming apparatus of claim 1, wherein a T-type peel strength between the belt body and the convex member is equal to or about 0.4 N/mm or more under an environment of 10° C. and 15% RH.

8. The endless belt for an image forming apparatus of claim 1, wherein the T-type peel strength between the belt body and the convex member is equal to or about 0.8 N/mm or more under an environment of 22° C. and 55% RH, and a thrust peel strength between the belt body and the convex member is from about 15 N/mm to about 25 N/mm under an environment of 22° C. and 55% RH.

9. The endless belt for an image forming apparatus of claim 1, wherein the belt body has a heat resistant temperature of equal to or about 1 50° C. or more.

10. The endless belt for an image forming apparatus of claim 1, wherein the belt body of the endless belt for an image forming apparatus comprises at least one selected from a polyimide resin and a polyamideimide resin.

11. A belt suspending apparatus for an image forming apparatus, comprising:
the endless belt for an image forming apparatus of claim 1; and
a plurality of suspending members for suspending the endless belt rotatably in a tensioned state from the inner surface side of the endless belt.

12. An image forming apparatus, comprising the endless belt for an image forming apparatus of claim 1.
